(19) United States
(12) Patent Application Publication
(10) Pub. No.: US 2015/0298341 A1
(43) Pub. Date: Oct. 22, 2015

(54) DEVICE FOR STAMPING CARDBOARD

(71) Applicant: Franz VOSSEN, Stockach (DE)

(72) Inventor: Franz Vossen, Stockach (DE)

(21) Appl. No.: 14/442,779

(22) PCT Filed: Nov. 13, 2013
(86) PCT No.: PCT/EP2013/073686

§ 371 Date: May 14, 2015

(30) Foreign Application Priority Data
Nov. 14, 2012 (DE) 20 2012 104 394.7

(51) Int. Cl. B26F 1/44

(52) U.S. Cl. CPC B26F 1/44; B26F 2001/4409

(57) ABSTRACT

A device (10) for punching sheet-like cardboard materials, with a punching plate (11; 11a) that intermittently accommodates the cardboard materials, wherein a preferably plate-like caliber element (16) is arranged in at least one corner region of the rectangular punching plate (11; 11a), and wherein at least one additional caliber element is arranged in an intermediate region (18) that lies between the corner regions, characterized in that the additional caliber element is realized in the form of an elongate caliber rod (20; 20a; 20b; 20c), wherein the caliber rod (20; 20a; 20b; 20c) has a length/width ratio (L/B) of at least 5:1.

### PRIOR ART

The invention pertains to a device for punching sheet-like cardboard materials.

A device of this type is known from DE 10 2008 051 357 A1 of the applicant. In the known device, it is proposed to arrange a plate-like caliber block with rectangular base in the four corner regions of a rectangular punching plate, wherein said caliber block serves for increasing the required punching pressure, for example, by approximately 15% such that a harmonic punch-cut, as well as a sound punching result, can be achieved during the punching of the cardboard materials.

Strip-shaped zones, in which no punching is carried out or no cardboard material lies on the punching plate, usually exist on the edge regions of the punching plate. The reason for this can be seen in that the cardboard materials need to be respectively introduced into the punching die or the punching device between the caliber elements or transported between the caliber elements. Consequently, the aforementioned publication also proposes to arrange another caliber element, which is realized identically to the caliber elements in the corner regions, between the corner regions of the punching plate. In order to additionally improve the punching result, it is in the latter-mentioned embodiment furthermore proposed to provide creasing lines on the longitudinal side of the punching plate in the intermediate regions between the caliber blocks, wherein said creasing lines are required for achieving the desired high-quality punching result. The effect of the aforementioned elements is based, among other things, on that the tendency to deform in the longitudinal direction, i.e. in the transport direction of the cardboard material, during the punching process is compensated by the elements because the force application takes place in the corner regions of the punching plate. The setup of such creasing lines in practical applications requires a height adjustment of the creasing lines. This setup is relatively elaborate and either requires the use of self-adhesive trim tape or strip-shaped elements that are glued onto the punching plate by means of instant adhesive. If self-adhesive elements are not used, problems arise, in particular, with respect to the handling of the instant adhesive that on the one hand makes it necessary to protect the operator from the adhesive and on the other hand requires a relatively big effort, in particular, for once again removing the trim tape from the punching plate. Furthermore, the removed trim tapes usually cannot be reused such that they accumulate in the form of waste.

### Disclosure of the Invention

Based on the above-described prior art, the invention aims to enhance a device for punching sheet-like cardboard materials in such a way that the adjustment or setup for generating the correct punching pressure that delivers sound punching results is simplified. According to the invention, this objective is attained with a device for punching sheet-like cardboard materials with the characteristics disclosed herein in that the additional caliber element is realized in the form of an elongate caliber rod, wherein the length/width ratio of the caliber rod amounts to at least 5:1, and wherein the longitudinal axis of the caliber rod is aligned with the lateral edge of the punching plate in the intermediate region between the two caliber blocks. Such a design of a caliber element has the advantage that it is possible to forgo a combination of caliber blocks and creasing or cutting lines in the intermediate region between two corner regions of a punching plate. The chosen length/width ratio simultaneously allows a fast installation of the caliber rods because the maximum number of caliber rods to be installed is limited. Consequently, the proposed system merely requires at least one caliber rod in addition to the caliber blocks arranged in the corner regions in order to respectively adjust or generate the correct punching pressure.

Advantageous enhancements of the inventive device for punching sheet-like cardboard materials are disclosed in the dependent claims. The scope of the invention includes all combinations of at least two characteristics disclosed in the claims, the description and/or the figures.

In a preferred embodiment of the device, it is proposed that a plurality of caliber rods, which are aligned with one another in the longitudinal direction, is provided in the intermediate region between the caliber blocks arranged in the corner regions. This provides the advantage that it suffices to remove individual caliber rods of the plurality of caliber rods provided in order to adjust the required punching pressure such that a relatively simple and precise adjustment of the punching pressure can be realized over the respective distance or width of the intermediate region.

According to a preferred geometric arrangement of the plurality of caliber rods, it is proposed that a plurality of caliber rods is arranged in the intermediate region, and that the caliber rods are arranged parallel to one another. Such an arrangement has the advantage that a relatively large number of caliber rods can be provided referred to a certain surface area of the intermediate region such that the removal of individual caliber rods allows a particularly sensitive adjustment of the punching pressure.

It is particularly preferred that the caliber rods are respectively realized identically, if applicable, with the exception of different lengths. This means, for example, that several standardized lengths of caliber rods are provided in the form of a modular system such that the intermediate region between the two caliber blocks arranged in the corner regions of the punching plate can be bridged, for example, with an integral multiple of caliber rods. The shorter the respective caliber rods used, the simpler and the more diverse the adjustment options with respect to the punching pressure over the width of the intermediate region.

It is particularly preferred that the caliber rods feature on a contact surface at least two fastening extensions that are spaced apart from one another and engage into recesses of the punching plate such that a press fit is produced. Such a design has the advantage of a particularly simple installation and removal of the caliber rods on/from the punching plate, particularly because the adhesive (instant adhesive) required for the fastening process in the prior art is eliminated. Furthermore, the design of the press fit or a corresponding tolerance of the fastening extensions and the recesses in the punching plate or a corresponding shape of the fastening extensions, as well as the choice of the material for the fastening extensions, makes it possible to adjust the required installation or press-in force of a caliber rod, as well as the forces required for removing a caliber rod, in a relatively simple fashion.

In order to compensate dimensional tolerances with respect to the fastening extensions on the caliber rod and the recesses in the punching plate, it is furthermore preferred that the fastening extensions feature flattenings, and that at least two flattenings are arranged offset relative to one another by 90° referred to the longitudinal direction of the caliber rod.

In a particularly preferred alternative embodiment of the fastening extensions, it is proposed that the fastening extensions feature several longitudinal ribs, preferably six longitudinal ribs, that are arranged at uniform angular distances from one another and extend in the longitudinal direction of the fastening extensions, wherein said longitudinal ribs extend radially to the longitudinal axis of the fastening extensions. Such a design proved particularly suitable for axially securing the caliber rods because it eliminates any relative movements between the fastening extensions and the receptacles (bores) for the fastening extensions.

The aforementioned secure anchoring of the fastening extensions can be optimized if the longitudinal ribs have a cross section that widens in a mushroom-like fashion in the circumferential direction as the distance from the longitudinal axis increases and/or if the cross section of the fastening extensions features a bore arranged in the longitudinal axis of the respective fastening extension such that an annular region is formed, from which the longitudinal ribs protrude radially.

A particularly sound adjustability of the punching pressure is achieved if a hole pattern with a plurality of recesses, which are arranged in a row and parallel to one another, is provided in the punching plate such that a caliber rod can be fastened on the punching plate in different positions.

According to a preferred embodiment of the caliber rod, it is proposed that this caliber rod is made of EPDM material, and that the fastening extensions are integrally formed onto the caliber rod.

The damping characteristic of the caliber rod can be additionally influenced if this caliber rod features a structured surface comprising, in particular, longitudinal grooves.

In another embodiment of the invention, it is proposed that the at least one caliber block arranged in a corner region of the punching plate features on its surface at least two fastening extensions that are spaced apart from one another and engage into recesses of the punching plate such that a press fit is produced, and that the shape and/or the cross section of these fastening extensions is/are identical to the shape and/or the cross section of the fastening extensions of the caliber rod. If a plurality of recesses for the fastening extensions is provided in the punching plate, such a design has the advantage that the caliber block can also be installed and removed, as well as fastened at different positions of the punching plate, in a relatively simple fashion.

Other characteristics, advantages and details of the invention are elucidated in the following description of preferred exemplary embodiments with reference to the drawings.

### BRIEF DESCRIPTION OF THE DRAWINGS

In these drawings:

FIG. 1 shows a top view of an inventive device for punching sheet-like cardboard materials,

FIG. 2 shows a perspective view of a caliber rod used in a device according to FIG. 1,

FIG. 3 shows perspective views of a caliber block used in the device according to FIG. 1,

FIG. 4 shows a caliber block that is modified in comparison with FIG. 3, namely also in the form of a perspective view,

FIG. 5 shows a top view of a device that is modified in comparison with FIG. 1 and in which no caliber blocks are used,

FIG. 6 shows a side view of a caliber rod with a modified fastening extension, and

FIG. 7 shows a section along the plane VII-VII in FIG. 6.

Identical elements or elements with identical function are identified by the same reference symbols in the figures.

### DETAILED DESCRIPTION

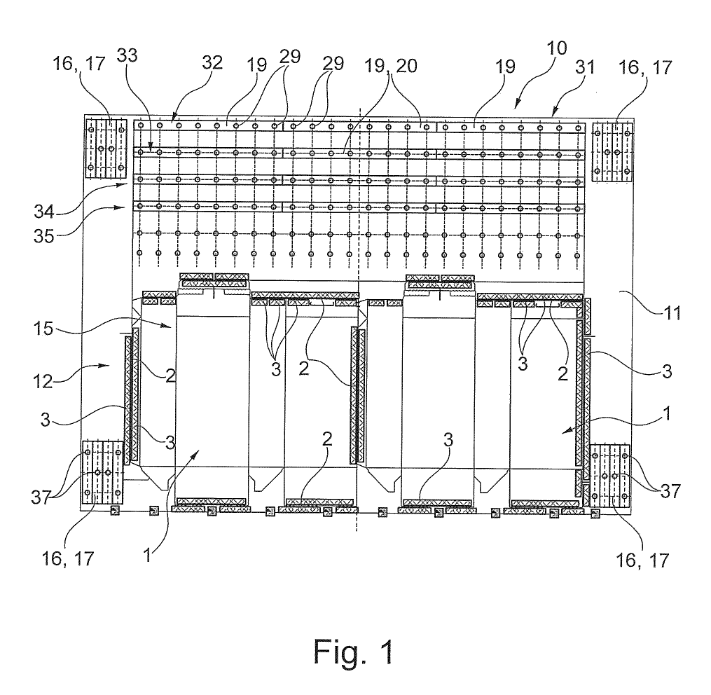

FIG. 1 shows an inventive device 10 for punching sheet-like cardboard materials. During each punching process, two blanks 1 are punched out of these cardboard materials by means of the device 10, wherein these blanks are then further processed, for example, into folding boxes or the like.

The device 10 comprises a rectangular punching plate 11 of a hard material, particularly of multiply glued wood, with a plane surface 12. On its edge, the punching plate 11 is encompassed by a not-shown frame that is connected to the punching plate 11, for example, by means of screw elements. To this effect, we refer to the disclosure of DE 10 2008 051 357 A1 of the applicant which in this respect forms part of this application and is incorporated herein by reference.

The actual punching die or the punching region 15 is arranged in a section of the punching plate 11. A caliber element 16 of identical design in the form of a caliber block 17 is respectively arranged in the four corner regions of the rectangular punching plate 11 in the exemplary embodiment. The arrangement of the caliber blocks 17 increases the required punching pressure, for example, by approximately 15% such that a harmonic punch-cut, as well as a sound punching result, is achieved. Since the punching region 15 is not arranged symmetrically referred to the caliber blocks 17 or to the punching plate 11, the punching plate 11 features an intermediate or compensation region 18 that is arranged adjacent to the punching region 15 and extends, in particular, between two caliber blocks 17 arranged in the corner regions of the punching plate 11 in the form of an intermediate zone. This compensation region 18 extends as far as the punching region 15.

A plurality of punching knives 2 is illustrated within the punching region 15, wherein said punching knives are bordered by hold-down elements 3 on both sides in order to produce clean cuts during the punching process.

Due to the punching knives 2 and the geometry of the blanks 1, an uneven pressure distribution results over the surface of the punching plate 11 during the punching process, wherein this uneven pressure distribution can be adjusted, according to the invention, by means of additional caliber elements 19 arranged in the compensation region 18.

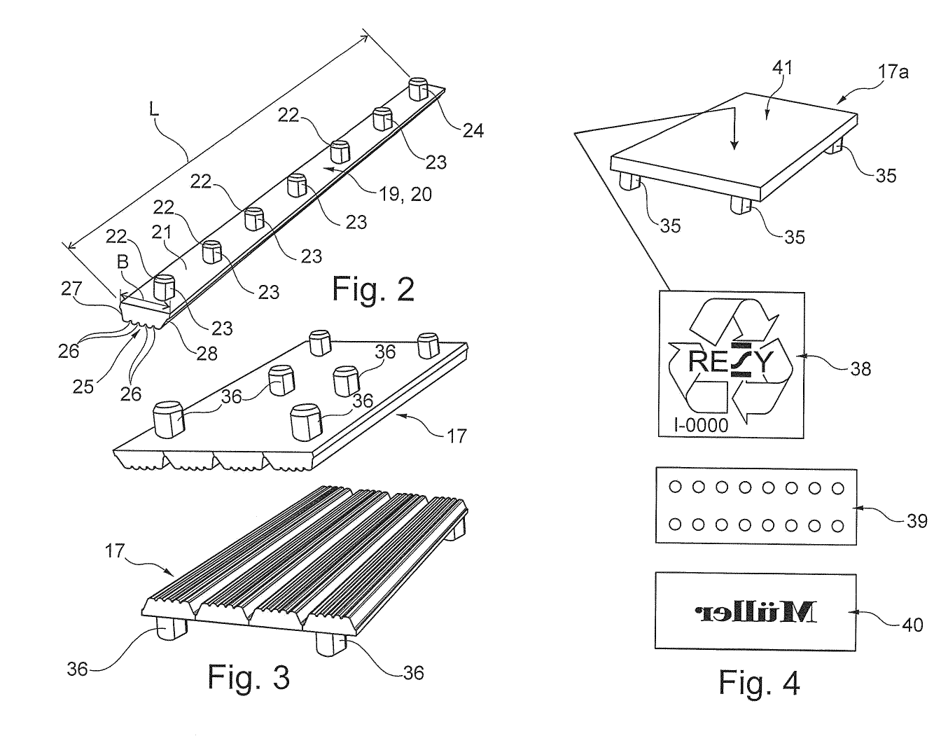

A synopsis of FIGS. 1 and 2, in particular, shows that the additional caliber element 19 is realized in the form of a caliber rod 20. The caliber rod 20 has an elongate or rod-like shape and a length/width ratio (L/B) of at least 5:1. The caliber rod 20 consists of plastic, particularly of an ethylene propylene diene monomer material with polymethylene (EPDM). The caliber rod 20 is preferably, but not restrictively, realized in the form of an injection-moulded part and features on a plane contact surface 21 several fastening extensions 22 that are uniformly spaced apart from one another and integrally formed onto the caliber rod 20, wherein seven fastening extensions are provided in the exemplary embodiment shown. Each of the fastening extensions 22 features at least one flattening 23, 24, wherein at least one flattening 23 on a first fastening extension 22 is arranged offset relative to a flattening 24 on another fastening extension 22 by 90°.

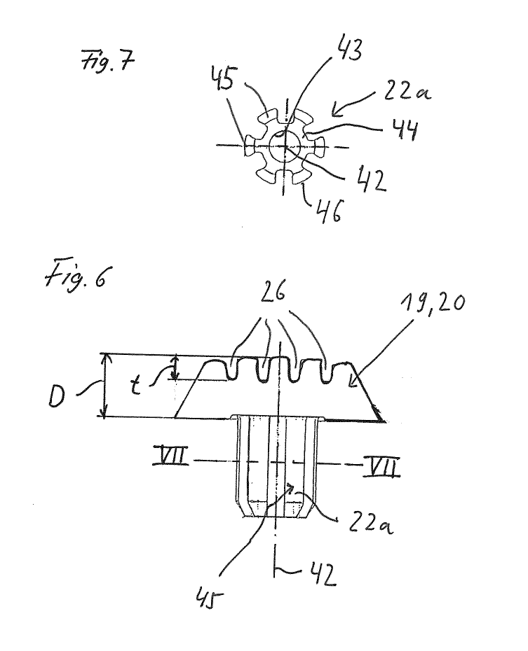

According to the illustrations in FIGS. 6 and 7, it is also possible to provide a fastening extension 22a, in the longitudinal axis 42 of which a blind hole 43 is produced. The blind hole 43 is surrounded by an annular region 44, wherein several longitudinal ribs 45, preferably between three and eight longitudinal ribs, arranged parallel to the longitudinal axis 42 extend radially outward from the aforementioned annular region at uniform angular distances from one another, and wherein six of these longitudinal ribs are provided in the exemplary embodiment shown. The cross section of the longitudinal ribs 45 increases in a mushroom-like fashion in the circumferential direction as the distance from the longitudinal axis 43 increases. The outer surfaces 46 of the longitudinal ribs 45 lie in recesses 29 in the compensation region 18, wherein a press fit of the caliber element 19, in which the annular region 44 is subjected to a slight elastic deformation, is achieved by dimensioning the outside diameter of the fastening extensions 22a and the recess 29 accordingly.

The surface 25 lying opposite of the contact surface 21 features, for example, four parallel longitudinal grooves 26 that are uniformly spaced apart from one another and extend over the entire length of the caliber rod 20. In the exemplary embodiment shown, the basic shape of the caliber rod 20 has a trapezoidal cross section with obliquely arranged lateral surfaces 27, 28. According to the illustration in FIG. 6, the depth t of the longitudinal grooves 26 referred to the thickness D of the caliber rod 20 lies between 30% and 50%, preferably about 45%, of the thickness D.

The fastening extensions 22 cooperate with recesses 29 in the form of respectively identical holes arranged in the compensation region 18. The recesses 29 or holes are produced, in particular, by means of a laser and therefore very precise with respect to their positioning and dimensional accuracy. The recesses 29 form a hole pattern, in which the recesses 29 are oriented perpendicular and parallel to an outer edge 31 of the punching plate 11 and uniformly spaced apart from one another. The hole pattern or the distance between the recesses 29 is naturally adapted to the distance between the fastening extensions 22 of the caliber rods 20 such that a caliber rod 20 with its fastening extensions 22 can cooperate with a plurality of different recesses 29 and be arranged on the compensation region 18 in different positions. The caliber rods 20 are held in the recesses 29 by means of a press fit realized by dimensioning the fastening extensions 22 and the recesses 29 accordingly. A total of four rows 32-35, which respectively feature three identically designed caliber rods 20, are illustrated in the exemplary embodiment according to FIG. 1, wherein the rows 32-35 are arranged parallel to one another, and wherein the caliber rods 20 directly follow one another and are aligned with one another in the longitudinal direction in each of the rows 32-35.

According to the invention, it would naturally also be possible, for example, to reduce the length of the caliber rods 20 such that a greater number of caliber rods 20 than three caliber rods 20 can be respectively arranged in a row 32-35. It would also be conceivable, according to the invention, to realize a caliber rod 20 with such a length that only a single caliber rod 20 is arranged in a row 32-35. The required punching pressure in the compensation region 18 can be very precisely adjusted with the arrangement and the number of caliber rods 20 used such that the punching quality can be optimized.

A synopsis of FIGS. 1 and 3, in particular, shows that the caliber blocks 17 are also equipped with fastening extensions 36 realized analogous to the fastening extensions 22 on the caliber rods 20. Correspondingly designed recesses 37 in the punching plate 11 make it possible to likewise fasten the caliber blocks 17 on the punching plate 11 by means of a press fit. With respect to the exact design or geometry and surface of the caliber blocks 17, we furthermore refer to DE 10 2008 051 357 A1 of the applicant.

According to FIG. 4, a block-shaped element 50 realized analogous to the caliber block 17 can also be used as a carrying element for various types of forming and marking parts. In this case, the parts 38-40 used, for example, as a logo, for perforations or for stamping dies are glued to the surface 41 of the element 50, wherein the element 50 features fastening extensions 35.

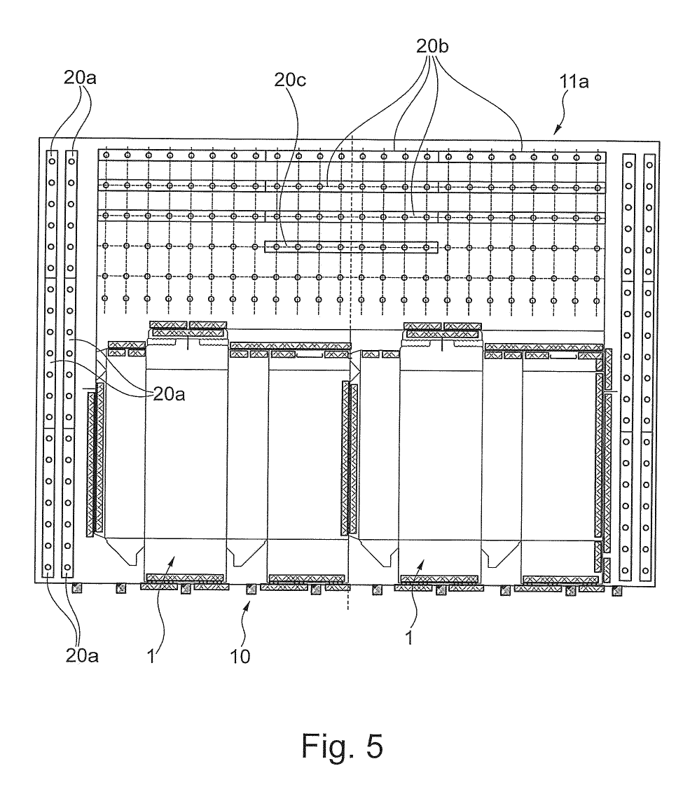

FIG. 5 ultimately shows another application of the invention, in which no caliber blocks 17 are provided in the corner regions of the punching plate 11a. Instead, caliber rods 20a, 20b and 20c are illustrated on three of four longitudinal edges of the punching plate 11a, wherein two rows with several identically designed caliber rods 20a are respectively arranged on the two narrow sides of the punching plate 11a. These caliber rods 20a are therefore also located in the corner regions of the punching plate 11a. In contrast, three rows with respectively identical caliber rods 20b, as well as a caliber rod 20c that has a greater length than the caliber rod 20b, are arranged on the one broadside of the punching plate 11a. The caliber rods 20a-20c are fastened analogous to the caliber rods 20 by means of not-shown fastening extensions 22 and recesses 29 in the punching plate 11a.

The above-described device 10 for punching sheet-like cardboard materials can be adapted and modified in various ways without deviating from the inventive idea.

1. A device (10) for punching sheet-like cardboard materials, with a punching plate (11; 11a) that intermittently accommodates the cardboard materials, wherein a plate-like caliber element (16) is arranged in at least one corner region of the rectangular punching plate (11; 11a), and wherein at least one additional caliber element is arranged in an intermediate region (18) that lies between the corner regions,
wherein the additional caliber element is realized in the form of an elongate caliber rod (20; 20a; 20b; 20c), wherein the caliber rod (20; 20a; 20b; 20c) has a length/width ratio (L/B) of at least 5:1.

2. The device according to claim 1, wherein a plurality of caliber rods (20; 20a; 20b; 20c), which are aligned with one another in the longitudinal direction, is provided in the intermediate region (18).

3. The device according to claim 1, wherein a plurality of caliber rods (20; 20a; 20b; 20c) is arranged in the intermediate region (18), and wherein the caliber rods (20; 20a; 20b; 20c) are arranged parallel to one another.

4. The device according to claim 2, wherein the caliber rods (20; 20a; 20b; 20c) are respectively realized identically.

5. The device according to claim 1, wherein the caliber rods (20; 20a; 20b; 20c) feature on a contact surface (21) at least two fastening extensions (22; 22a) that are spaced apart from one another and engage into recesses (29) in the punching plate (11; 11a) such that a press fit is produced.

6. The device according to claim 5, wherein the fastening extensions (22) feature flattenings (23, 24), and that at least two flattenings (23, 24) are arranged offset relative to one another by 90° referred to the longitudinal direction of the caliber rod (20; 20a; 20b; 20c).

7. The device according to claim 5, wherein the fastening extensions (22a) feature several longitudinal ribs (45), that are arranged at uniform angular distances from one another and extend in the longitudinal direction of the fastening extensions (22a), wherein said longitudinal ribs extend radially to the longitudinal axis (42) of the fastening extensions (22a).

8. The device according to claim 7, wherein the longitudinal ribs (45) have a cross section that widens in a mushroom-like fashion in the circumferential direction as the distance from the longitudinal axis (42) increases.

9. The device according to claim 7, wherein the cross section of the fastening extensions (22a) features a bore (43) arranged in the longitudinal axis (42) of the respective fastening extension (22a) such that an annular region (44) is formed, from which the longitudinal ribs (45) protrude radially.

10. The device according to claim 5, wherein a hole pattern with a plurality of recesses (29), which are arranged in a row and parallel to one another, is provided in the punching plate (11; 11a) such that a caliber rod (20; 20a; 20b; 20c) can be fastened on the punching plate (11; 11a) in different positions by means of the recesses (29).

11. The device according to claim 1, wherein the caliber rod (20; 20a; 20b; 20c) is made of plastic and the fastening extensions (22; 22a) are integrally formed onto the caliber rod (20; 20a; 20b; 20c).

12. The device according to claim 1, wherein the caliber rod (20; 20a; 20b; 20c) features a structured surface with a plurality of parallel longitudinal grooves (26), wherein the depth (t) of the longitudinal grooves (26) referred to the thickness (D) of the caliber rod (20; 20a; 20b; 20c) lies between 30% and 50%, preferably about 45%, of the thickness (D).

13. The device according to claim 5, wherein the at least one caliber block (17) features at least two fastening extensions (35) that are spaced apart from one another and engage into recesses (29) in the punching plate (11; 11a) such that a press fit is produced, and in that wherein the shape and/or the cross section of the fastening extensions (35) is/are identical to the shape and/or the cross section of the fastening extensions (22; 22a) of the caliber rod (20; 20a; 20b; 20c).

14. The device according to claim 1, wherein the caliber element arranged in at least one corner region is also realized in the form of a caliber rod (20a).

15. The device according to claim 1, wherein a block-shaped element (50) is provided as carrier for a part (38-40) used for labeling, stamping or perforating purposes, and wherein the element (50) can be fastened on the carrier plate (11; 11a) by means of fastening extensions (35) such that a press fit is produced.

16. The device according to claim 7, wherein the several longitudinal ribs (45) comprise six longitudinal ribs.

17. The device according to claim 12, wherein the thickness of the caliber rod is about 45% of the thickness (D).
